(19) United States
(12) Patent Application Publication
(10) Pub. No.: US 2024/0121650 A1
(43) Pub. Date: Apr. 11, 2024

(54) METHOD AND APPARATUS FOR REPORTING MEASUREMENT

(71) Applicant: Samsung Electronics Co., Ltd., Suwon-si (KR)

(72) Inventors: Xingyu HAN, Beijing (CN); Dingye ZHANG, Beijing (CN); Hong WANG, Beijing (CN)

(21) Appl. No.: 18/481,523

(22) Filed: Oct. 5, 2023

(30) Foreign Application Priority Data
Oct. 10, 2022 (CN) 202211237082.2
Mar. 30, 2023 (CN) 202310332576.7

(51) Int. Cl. H04W 24/10

(52) U.S. Cl. CPC H04W 24/10; H04W 88/085

(57) ABSTRACT

The disclosure relates to a 5^{th} generation (5G) or 6^{th} generation (6G) communication system for supporting a higher data transmission rate. A method and a device of measurement reporting related to user experience, and a method performed by a first node in a wireless communication network are provided. The method includes receiving, from a third node, third information, and receiving, from a second node, fifth information. The fifth information includes at least one of configuration information of a radio bearer, configuration information of a radio bearer carrying a measurement report, configuration information of a signaling radio bearer (SRB), configuration information related to a measurement, configuration information related to a duration, or information for requesting or indicating the duration. The third information includes information on at least one measured cell.

### CROSS-REFERENCE TO RELATED APPLICATION(S)

This application is based on and claims priority under 35 U.S.C. § 119(a) of a Chinese patent application number 202211237082.2, filed on Oct. 10, 2022, in the China National Intellectual Property Administration, and of a Chinese patent application number 202310332576.7, filed on Mar. 30, 2023, in the China National Intellectual Property Administration, the disclosure of each of which is incorporated by reference herein in its entirety.

### BACKGROUND

### 1. Field

The disclosure relates to a wireless communication technology. More particularly, the disclosure relates to a method and device of measurement reporting on user experience.

### 2. Description of Related Art

5^{th} generation (5G) mobile communication technologies define broad frequency bands such that high transmission rates and new services are possible, and can be implemented not only in “Sub 6 GHz” bands, such as 3.5 GHz, but also in “above 6 GHz” bands referred to as millimeter wave (mmWave) including 28 GHz and 39 GHz. In addition, it has been considered to implement 6^{th} generation (6G) mobile communication technologies (referred to as beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device of measurement reporting on user experience.

Additional aspects will be set forth in part in the description which follows and, in part, will be apparent from the description, or may be learned by practice of the presented embodiments.

In accordance with an aspect of the disclosure, a method performed by a first node in a wireless communication network is provided. The method includes receiving, from a third node, third information, and receiving, from a second node, fifth information. For example, the fifth information includes at least one of configuration information of a radio bearer, configuration information of a radio bearer carrying a measurement report, configuration information of a signaling radio bearer (SRB), configuration information related to a measurement, configuration information related to a duration, or information for requesting or indicating the duration. For example, the third information includes information on at least one measured cell.

In an embodiment of the disclosure, the method further comprises storing at least one piece of the received third information, and transmitting, to the second node or a fourth node, sixth information. For example, the sixth information includes at least one of identity information of a radio bearer, information on the at least one measured cell, the measurement report, or time information corresponding to the measurement.

In an embodiment of the disclosure, the method further comprises transmitting, to the second node, fourth information. For example, the fifth information is received based on the fourth information, and the fourth information includes identity information of user equipment (UE) context.

In an embodiment of the disclosure, the configuration information related to the duration includes information about a duration in which the first node does not need to perform context exchange with the second node, or a duration in which the first node keeps the context received from the second node.

In an embodiment of the disclosure, the method further comprises transmitting, to the second node, seventh information, and receiving, from the second node, eighth information, based on the seventh information. In an embodiment of the disclosure, the seventh information includes at least one of indication for indicating that the measurement report is stored at the first node, indication for indicating that information is received by the first node through the signaling carried by the SRB, configuration information related to a measurement, modified configuration information related to the measurement, an acknowledge to the configuration information related to the measurement, configuration information related to the duration, an acknowledge to the duration, or a request or an indication related to the duration. In an embodiment of the disclosure, the eighth information includes at least one of configuration information of a radio bearer, configuration information of a radio bearer carrying the measurement report, configuration information of the SRB, RRC message containing the configuration related to the measurement, configuration information related to the duration, or an acknowledge to the duration.

In an embodiment of the disclosure, the third information further includes at least one of indication information for indicating that the third information contains the measurement report, the measurement report, time information corresponding to a measurement, or configuration information related to the measurement.

In an embodiment of the disclosure, the time information corresponding to the measurement includes time information related to the at least one measured cell, and the configuration information related to the measurement includes at least one of a reporting periodicity related to the measurement, or a triggering condition related to measurement reporting.

In an embodiment of the disclosure, the information on the at least one measured cell includes at least one of an identity corresponding to the at least one measured cell, or an identity list of the at least one measured cell.

In an embodiment of the disclosure, the method of claim 1, further comprises recovering the measurement report, based on the fifth information.

In accordance with another aspect of the disclosure, a method performed by a second node in a wireless communication network is provided. The method includes receiving, from a first node, fourth information, and transmitting, to the first node, fifth information, based on the fourth information. For example, the fourth information includes identity information of user equipment, UE, context. For example, the fifth information includes at least one of configuration information of a radio bearer, configuration information of a radio bearer carrying a measurement report, configuration information of an SRB, configuration information related to a measurement, configuration information related to a duration, or information for requesting or indicating the duration.

In an embodiment of the disclosure, the method further comprises receiving, from the first node, sixth information. For example, the sixth information includes at least one of identity information of a radio bearer, information on the at least one measured cell, the measurement report, or time information corresponding to the measurement.

In an embodiment of the disclosure, the configuration information related to the duration includes information about a duration in which the first node does not need to perform context exchange with the second node, or a duration in which the first node keeps the context received from the second node.

In an embodiment of the disclosure, the method further comprises receiving, from the first node, seventh information, and transmitting, to the first node, eighth information, based on the seventh information. For example, the seventh information includes at least one of indication for indicating that the measurement report is stored at the first node, indication for indicating that information is received by the first node through the signaling carried by the SRB, configuration information related to a measurement, modified configuration information related to the measurement, an acknowledge to the configuration information related to the measurement, configuration information related to the duration, an acknowledge to the duration, or a request or an indication related to the duration. For example, the eighth information includes at least one of configuration information of a radio bearer, configuration information of a radio bearer carrying the measurement report, configuration information of the SRB, RRC message containing the configuration related to the measurement, configuration information related to the duration, or an acknowledge to the duration.

In accordance with another aspect of the disclosure, a first node performed in a wireless communication network is provided. The first node includes a transceiver, and at least one processor coupled to the transceiver and configured to control the transceiver to receive, from a third node, third information, and control the transceiver to receive, from a second node, fifth information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

FIG. 1A is a system architecture diagram of system architecture evolution (SAE) according to an embodiment of the disclosure;

FIG. 1B is a schematic diagram of an initial overall architecture of 5^{th} generation (5G) according to an embodiment of the disclosure;

FIG. 2A illustrates a structure of a base station according to an embodiment of the disclosure;

FIG. 2B is illustrates a structure of a g node B (gNB) according to an embodiment of the disclosure;

FIG. 2C illustrates a structure of an ng-evolved node B (eNB) according to an embodiment of the disclosure;

FIG. 3A illustrates a message transmission and reception for enhancement of measurement reporting based on a small data transmission (SDT) between third node and fifth node according to an embodiment of the disclosure;

FIG. 3B illustrates a message transmission and reception for enhancement of measurement reporting based on a SDT between first node and third node according to an embodiment of the disclosure;

FIG. 3C illustrates a message transmission and reception for enhancement of measurement reporting based on a SDT between first node and second node according to an embodiment of the disclosure;

FIG. 3D illustrates a message transmission and reception for enhancement of measurement reporting based on a SDT according to an embodiment of the disclosure;

FIG. 3E illustrates a message transmission and reception for enhancement of measurement reporting based on the SDT between the first node and the second node according to an embodiment of the disclosure;

FIG. 3F is a flowchart for enhancement of radio access network (RAN) visible quality of experience (QoE) (RVQoE) measurement reporting based on the SDT according to an embodiment of the disclosure;

FIG. 3G is a flowchart for enhancement of RVQoE measurement reporting based on the SDT according to an embodiment of the disclosure;

FIG. 3H illustrates a message transmission and reception for enhancement of RVQoE measurement reporting based on the SDT between nodes according to an embodiment of the disclosure;

FIG. 3I is a flowchart for enhancement of RVQoE measurement reporting based on the SDT between the first node, the second node and third node according to an embodiment of the disclosure;

FIG. 4A illustrates a message transmission and reception for enhancement of measurement reporting based on service and/or slice between the first node and the third node according to an embodiment of the disclosure;

FIG. 4B illustrates a message transmission and reception for enhancement of measurement reporting based on service and/or slice between the first node and the second node according to an embodiment of the disclosure;

FIG. 4C illustrates an enhancement of RVQoE measurement reporting based on service and/or slice according to an embodiment of the disclosure;

FIG. 5 is a block diagram of a network node device according to an embodiment of the disclosure;

FIG. 6 schematically illustrates a Base station according to an embodiment of the disclosure;

FIG. 7 illustrates a user equipment (UE) according to an embodiment of the disclosure; and

FIG. 8 illustrates an entity according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed functions, operations or components which can be used in various embodiments of the disclosure and does not limit one or more additional functions, operations, or components. The terms, such as “include” and/or “have” may be construed to denote a certain characteristic, number, step, operation, constituent element, component or a combination thereof, but may not be construed to exclude a possibility of the existence of one or more other characteristics, numbers, steps, operations, constituent elements, components or combinations thereof.

The term “or” used in various embodiments of the disclosure includes any or all of combinations of listed items. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

In order to meet an increasing demand for wireless data communication services since a deployment of 4th generation (4G) communication system, efforts have been made to develop an improved 5G or pre-5G communication system. Therefore, the 5G or pre-5G communication system is also called “beyond 4G network” or “post long-term evolution (LTE) system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

With the gradual maturity of 5G commercial network new radio (NR) access network), the scope to which quality of experience (QoE) technology is applied is also expanding continuously. In order to better support the user experience of multicast/broadcast services, the corresponding research and standardization work have also been launched.

In the mobile communication system, more and more new services need to be supported. Therefore, it is required for the NR to support user experience reporting (including but not limited to QoE reporting and/or RVQoE reporting). For example, as for the case of multicast/broadcast services or terminals in an idle state or an inactive state, it needs to enhance the user experience reporting to optimize the network. The disclosure mainly relates to enhancement of measurement reporting of user experience (for example, QoE, RVQoE, or the like).

According to an aspect of an embodiment of the disclosure, there is provided a method performed by a first node in a wireless communication network, the method comprising:
receiving third information from a third node; and
receiving fifth information from a second node,
wherein the fifth information includes at least one of the following:
Configuration information of a radio bearer;
Configuration information of a radio bearer carrying a measurement report; or
Configuration information of a signaling radio bearer SRB1 or SRB2 or SRB4;
wherein the third information includes information on measured cell(s).

According to an embodiment of the disclosure, the third information further includes at least one of the following:
Indication information for indicating that the third information contains the measurement report;
Measurement report;
Time information corresponding to a measurement; or
Configuration information related to the measurement.

According to an embodiment of the disclosure, the information on the measured cell(s) includes at least one of the following:
Identity(ies) of the measured cell(s); or
Identity list of the measured cell(s).

According to the embodiment of the disclosure, the identity(ies) of the measured cell(s) includes at least one of the following:
NR cell identity (NCI);
NR cell global identity (NCGI);
NR physical cell identity (NR PCI);
Cell identity (cell ID);
Cell global identity (cell global ID); or
Physical cell identity (physical cell ID);
and/or
the identity list of the measured cell(s) contains at least one of the following:
NR cell identity (NCI) list;
NR cell global identity (NCGI) list;
NR physical cell identity (NR PCI) list;
Cell identity (cell ID) list;
Cell global identity (cell global ID) list; or
Physical cell identity (physical cell ID) list.

According to the embodiment of the disclosure, the time information corresponding to the measurement includes the time information related to the measured cell(s), or
wherein the configuration information related to the measurement includes at least one of a reporting periodicity related to the measurement and a triggering condition related to the measurement reporting.

According to the embodiment of the disclosure, the method further comprises:
recovering the measurement report based on the fifth information.

According to the embodiment of the disclosure, the method further comprises:
storing or keeping all or part of the received third information, and/or
sending sixth information to the second node or the fourth node;
wherein the sixth information includes at least one of the following:
Identity information of a radio bearer;
Information on the measured cell(s);
Measurement report; or
Time information corresponding to the measurement.

According to another aspect of an embodiment of the disclosure, there is provided a method performed by a second node in a wireless communication network, the method comprising:
receiving fourth information from the first node;
sending fifth information to the first node based on the fourth information; and/or
modifying configuration information related to a measurement based on the fourth information;
wherein the fourth information includes identity information of UE context; and
wherein the fifth information includes at least one of the following:
Configuration information of a radio bearer;
Configuration information of a radio bearer carrying measurement report;
Configuration information of a signaling radio bearer SRB1 or SRB2 or SRB4;
Configuration information related to the measurement;
Configuration information related to a duration; or
Information for requesting or indicating the duration.

According to an embodiment of the disclosure, the fourth information further includes:

Indication for indicating that the measurement report is kept and/or stored at the first node.

According to an embodiment of the disclosure, the duration includes a duration in which the first node does not need to perform context interaction/exchange with the second node, or a duration in which the first node keeps the context received from the second node.

According to the embodiment of the disclosure, the method further comprises:
sending sixth information to the first node and/or a fourth node;
wherein the sixth information includes at least one of the following:
Identity information of a radio bearer;
Information on measured cell(s);
Measurement report; or
Time information corresponding to the measurement.

According to the embodiment of the disclosure, the method further comprises:
receiving seventh information from the first node; and
sending eighth information to the first node according to the seventh information,
wherein the seventh information includes at least one of the following:
Indication for indicating that the measurement report is kept and/or stored at the first node;
Indication for indicating that information is received by the first node through the signaling carried by a signaling radio bearer SRB4;
Configuration information related to the measurement;
Modified configuration information related to the measurement;
Acknowledge/confirm to configuration information related to the measurement;
Configuration information related to a duration;
Acknowledge/confirm to the duration; or
Request or indication related to the duration,
wherein the eighth information includes at least one of the following:
Configuration information of a radio bearer;
Configuration information of a radio bearer carrying the measurement report;
Configuration information of a signaling radio bearer SRB1 or SRB2 or SRB4;
RRC message containing the configuration related to the measurement;
Configuration information related to the duration; or
Acknowledge/confirm to the duration.

According to another aspect of an embodiment of the disclosure, there is provided a method performed by a third node in a wireless communication network, the method comprising:
receiving thirteenth information on a measurement configuration from the first node or the second node;
sending a report on measurement.

According to an embodiment of the disclosure, wherein the sending the report on the measurement comprises:
sending third information to the first node,
wherein the third information includes at least one of the following:
Indication information for indicating that the third information contains a measurement report;
Measurement report;
Time information corresponding to the measurement; or
Configuration information related to the measurement.

According to an embodiment of the disclosure, the thirteenth information includes at least one of:
Configuration information related to the measurement;
Modified configuration information related to the measurement;
Configuration information of minimization of drive tests measurement; or
Information indicating whether the minimization of drive tests measurement is aligned with a quality of experience (QoE) measurement.

According to the embodiment of the disclosure, the method further comprises:
receiving a request message sent by a fifth node to request the identity information of a cell for the UE currently.

According to the embodiment of the disclosure, the method further comprises:
associating the information on the measured cell(s) with the measurement report or adding the information on the measured cell(s) to the measurement report.

According to an embodiment of the disclosure, the method further comprises:
sending the information on the measured cell(s) to the fifth node; and
receiving first information from the fifth node;
wherein the first information includes at least one of the following:
Measurement report;
Information on the measured cell(s); or
Time information corresponding to the measurement.

According to another aspect of an embodiment of the disclosure, there is provided a method performed by a first node in a wireless communication network, the method comprising:
receiving ninth information from a third node; and
determining service and/or slice information reported by a measurement based on the received ninth information,
wherein the ninth information includes at least one of the following:
First identity for identifying multicast/broadcast service (MBS); or
Slice group identity (NSAG ID, network slice AS group ID).

According to an embodiment of the disclosure, the ninth information further includes at least one of the following:
Multicast/broadcast service session identity (MBS Session ID);
Quality of service flow identity (QFI, QoS Flow ID);
Multicast radio bearer identity (MRB ID);
Slice identity (slice ID or S-NSSAI);
Cell identity;
Cell identity List;
Packet data unit set sequence number (PDU set sequence number);
List of packet data unit set sequence number;
Range of packet data unit set sequence number;
Packet data unit sequence number within packet data unit set;
List of packet data unit sequence number within packet data unit set;
Range of packet data unit sequence number within packet data unit set; or
Information related to packet data unit set importance (PDU set importance).

According to the embodiment of the disclosure, the method further comprises:
receiving tenth information from a second node, wherein the tenth information includes at least one of:
Association information or mapping information between multicast/broadcast service session identity and a first identity for identifying the multicast/broadcast service (MBS);
Configuration information of a radio bearer;
Configuration information of a radio bearer carrying a measurement report; or
Configuration information of a signaling radio bearer SRB1 or SRB2 or SRB4.

According to another aspect of an embodiment of the disclosure, there is provided a method performed by a second node in a wireless communication network, the method comprising:
receiving twelfth information from a first node; and
sending tenth information to the first node based on the twelfth information;
wherein the tenth information includes at least one of the following:
Association information or mapping information between multicast/broadcast service session identity and a first identity for identifying the multicast/broadcast service (MBS);
Configuration information of a radio bearer;
Configuration information of a radio bearer carrying a measurement report; or
Configuration information of a signaling radio bearer SRB1 or SRB2 or SRB4.

According to an embodiment of the disclosure, the twelfth information includes association information between a slice group (NSAG, network slicing AS group) and slice(s).

According to another aspect of an embodiment of the disclosure, it is provided with a method performed by a third node in a wireless communication network, the method comprising:
receiving eleventh information from a fifth node;
sending ninth information to a first node based on the eleventh information;
wherein the ninth information includes at least one of the following:
First identity for identifying multicast/broadcast service (MBS); or
Slice group identity (NSAG ID, network slice AS group ID).

According to an embodiment of the disclosure, the ninth information further includes at least one of the following:
Multicast/broadcast service session identity (MBS session ID);
Quality of service flow identity (QFI, QoS Flow ID);
Multicast radio bearer identity (MRB ID);
Slice identity (slice ID or S-NSSAI);
Cell identity; or
Cell identity List;

According to an embodiment of the disclosure, the eleventh information includes a measurement report.

According to another aspect of an embodiment of the disclosure, there is provided a node device in a wireless communication network, including a transceiver; and a processor coupled with the transceiver and configured to perform the method according to the above embodiment.

The disclosure provides a method and device related to measurement reporting of user experience (e.g., QoE, RVQoE, or the like), which ensures that a base station can receive radio access network visible measurement related to user experience for multicast/broadcasting services, thus enabling to enhance and optimize subsequent data transmission.

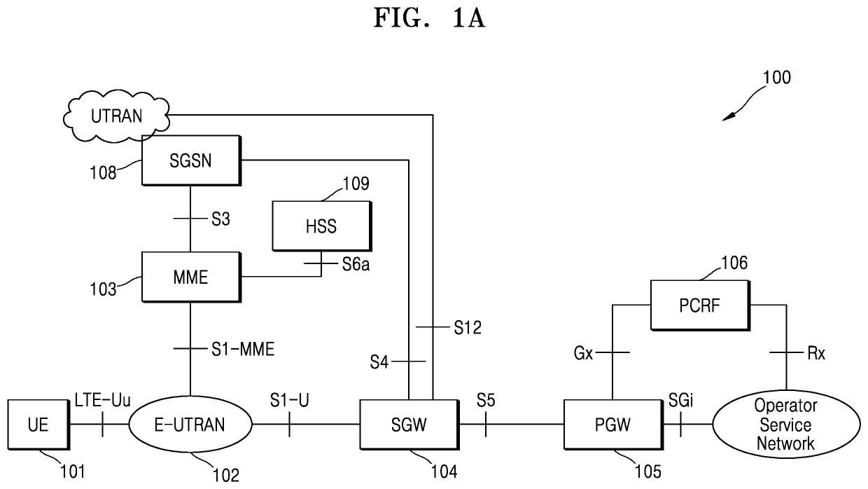

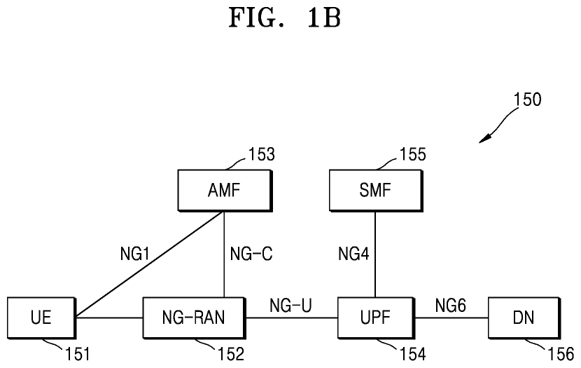

FIGS. 1A, 1B, 2A to 2C, 3A to 3I, 4A to 4C and 5 to 8 discussed below and various embodiments for describing the principles of the disclosure in the patent document are only for illustration and should not be interpreted as limiting the scope of the disclosure in any way. Those skilled in the art will understand that the principles of the disclosure can be implemented in any suitably arranged system or device.

Various embodiments of the disclosure are further described below with reference to the accompanying drawings.

The text and drawings are provided as examples only to help understand the disclosure. They should not be interpreted as limiting the scope of the disclosure in any way. Although certain embodiments and examples have been provided, based on the disclosure herein, it will be apparent to those skilled in the art that changes may be made to the illustrated embodiments and examples without departing from the scope of the disclosure.

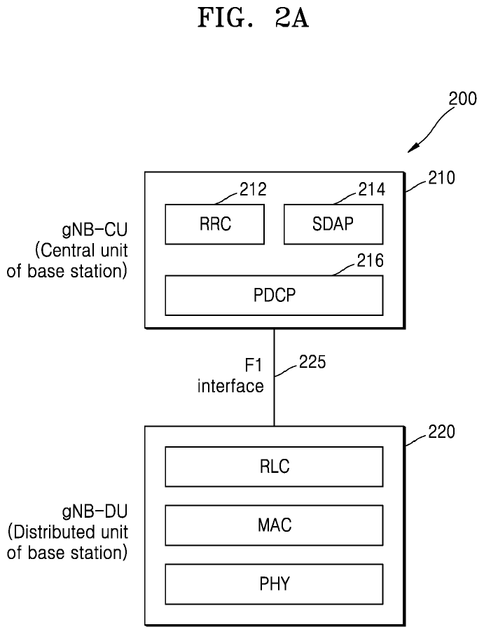

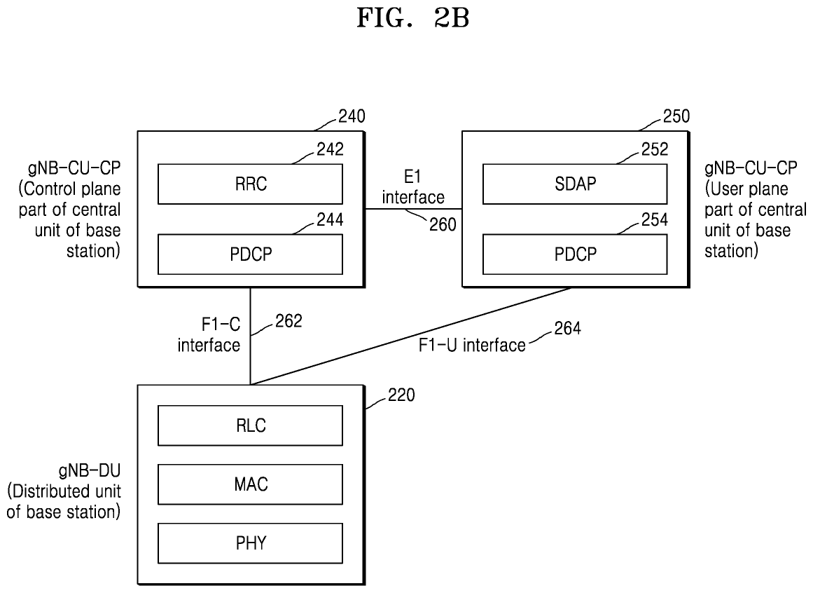

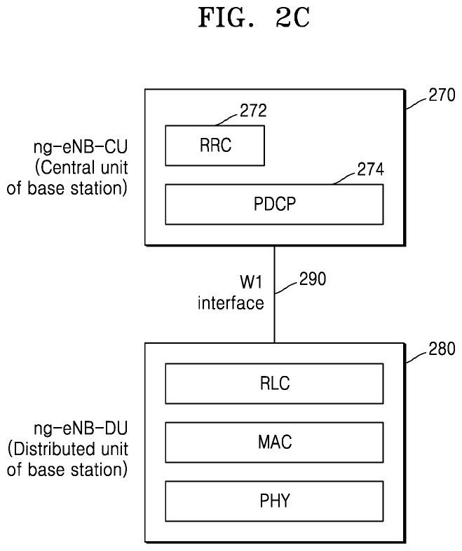

FIGS. 1A, 1B, and 2A to 2C discussed below and various embodiments for describing the principles of the disclosure in this patent document are for illustration only, and should not be interpreted as limiting the scope of the disclosure in any way. Those skilled in the art will understand that the principles of the disclosure can be implemented in any suitably arranged system or device.

FIG. 1A is a system architecture 100 of a system architecture evolution (SAE) according to an embodiment of the disclosure.

Referring to FIG. 1A, a user equipment (UE) 101 may be a terminal device for receiving data. An evolved universal terrestrial radio access network (E-UTRAN) 102 may be a radio access network, which includes a macro base station (for example, eNodeB, NodeB, or the like) that provides the UE 101 with interfaces to access the radio network. A mobility management entity (MME) 103 is responsible for managing mobility context, session context and security information of the UE 101. A serving gateway (SGW) 104 mainly may provide functions of user plane, and the MME 103 and the SGW 104 may be in the same physical entity. A packet data network gateway (PGW) 105 may be responsible for functions of charging, lawful interception, or the like, and may be in the same physical entity as the SGW 104. A policy and charging rules function (PCRF) entity 106 may provide quality of service (QoS) policies and charging criteria. A general packet radio service support node (SGSN) 108 may be a network node device that provides routing for data transmission in a universal mobile telecommunications system (UMTS). A home subscriber server (HSS) 109 is a home subsystem of the UE 101, and is responsible for protecting user information including a current location of the UE 101, an address of a serving node, user security information, and packet data context of the UE 101, or the like.

FIG. 1B is a system architecture according to an embodiment of the disclosure.

Referring to FIG. 1B, in an embodiment of the disclosure, the system architecture 150 may be used without departing from the scope of the disclosure. User equipment (UE) 151 may be a terminal device for receiving data. For example, the UE 101 may correspond to the UE 151. A next generation radio access network (NG-RAN) 152 is a radio access network, which includes a base station (for example, a gNB, an eNB connected to 5G core (5GC) network, or the like, (e.g., the eNB connected to the 5GC is also referred to as ng-gNB)) that provides the UE 151 with interfaces to access the radio network. An access control and mobility management function (AMF) entity 153 may be responsible for managing mobility context and security information of the UE 151. A user plane function (UPF) entity 154 mainly provide functions of user plane. A session management function (SMF) entity 155 may be responsible for session management. A data network (DN) 156 may include, for example, services of operators, access of Internet and service of third parties.

In a new radio (NR) system, in order to support network function virtualization and more efficient resource management and scheduling, a base station (for example, gNB, ng-eNB, or the like) that provides a terminal(s) (or, at least one UE) with a radio network interface may be further divided into a central unit of base station (for example, a centralized unit gNB central uniting-eNB central unit (gNB-CU/ng-eNB-CU)) and a distributed unit of base station (for example, a distributed unit gNB distributed uniting-eNB distributed unit (gNB-DU/ng-eNB-DU)) (abbreviated as CU and DU in the disclosure), as illustrated in FIG. 2A.

FIG. 2A illustrates a structure 200 of a base station according to an embodiment of the disclosure.

Referring to FIG. 2A, the gNB-CU 210 has a radio resource control (RRC) layer 212, a service data adaptation protocol (SDAP) layer 214, a packet data convergence protocol (PDCP) protocol layer 216, and the like, and the ng-eNB-CU has RRC and PDCP layers. The gNB-DU/ng-eNB-DU has radio link control protocol (RLC), medium access control (MAC) and physical layer, or the like. There is a standardized public interface F1 225 between the gNB-CU 210 and a gNB-DU 220, and there is a standardized public interface W1 between the ng-eNB-CU and the ng-eNB-DU.

FIG. 2B illustrates a structure of a gNB according to an embodiment of the disclosure.

Referring to FIG. 2B, the F1 interface 225 may be divided into a control plane F1-C and a user plane F1-U. The transport network layer of the F1-C is based on IP transport. For the more reliable signaling transmission, the SCTP protocol may be added over the IP. The protocol of the application layer may be an FlAP, referring to 3GPP TS38.473. The SCTP can provide reliable application layer message transmission. The transport layer of the F1-U is the UDP/IP, and the GTP-U is used to carry user plane protocol data units (PDUs) above the UDP/IP.

Further, for the gNB-CU, as illustrated in FIG. 2B, the gNB-CU 210 may include a gNB-CU-CP 240 (the control plane part of the centralized unit of the base station) and a gNB-CU-UP 250 (the user plane part of the centralized unit of the base station), wherein the gNB-CU-CP 240 may contain functions of the control plane of the base station and has a RRC layer 242 and PDCP protocol layers 244, and the gNB-CU-UP 250 may contain functions of the user plane of the base station and has a SDAP layer 252 and a PDCP protocol layer 254. There is a standardized public interface E1 260 between the gNB-CU-CP 240 and gNB-CU-UP 250, and the protocol is E1AP, referring to 3GPP TS38.463.

The interface between the control plane part of the centralized unit of the base station and the distributed unit of the base station is an F1-C interface 262, that is, the control plane interface of the F1, and the interface between the user plane part of the centralized unit of the base station and the distributed unit of the base station is an F1-U interface 264, that is, the user plane interface of the F1.

FIG. 2C illustrates a structure of an ng-eNB according to an embodiment of the disclosure.

Referring to FIG. 2C, in addition, in the NR system, the base station accessing to the 5G core network which provides the E-UTRA user plane and control plane is called the ng-eNB. In order to support the virtualization, such a base station (ng-eNB) can also be further divided into a centralized unit ng-eNB-CU 270 (gNB central unit/ng-eNB central unit) and a distributed unit ng-eNB-DU 280 (gNB distributed uniting-eNB distributed unit) (abbreviated as the CU and DU in the disclosure), as illustrated in FIG. 2C. The ng-eNB-CU 270 may have an RRC layer 272 and a PDCP layer 274.

The gNB-DU 220 and ng-eNB-DU 280 may have radio link control protocol (RLC) layer, medium access control (MAC) layer and physical (PHY) layer, or the like. There is a standardized public interface W1 290 between the ng-eNB-CU and the ng-eNB-DU. The W1 interface 290 may be divided into a control plane W1-C and a user plane W1-U. The transport network layer of the W1-C is based on IP transport. For more reliable signaling transmission, the SCTP protocol is added over the IP. The protocol of the application layer is a W1AP, referring to 3GPP TS37.473. The transport layer of the W1-U is the UDP/IP, and the GTP-U is used to carry the user plane protocol data units (PDUs) above the UDP/IP.

Before introducing specific embodiments of the disclosure, some assumptions and some definitions of the disclosure are given below.

The message names in the disclosure may be only examples, and other message names can be used.

The “first” and “second” included in the message name of the disclosure may be only examples of messages and do not represent a performing order.

Detailed description of operations irrelevant to the disclosure may be omitted in the disclosure.

In an embodiment of the disclosure, the operations in each flow can be performed in combination with each other or independently. The performing operations of each flow may be only examples, and other possible performing orders are not excluded. In addition, some operations can be omitted.

In an embodiment of the disclosure, the base station may be a 5G base station (such as gNB, ng-eNB), a 4G base station (such as eNB), a 6G base station or other types of access nodes.

In an embodiment of the disclosure, data transmission may refer to reception or transmission of data.

In an embodiment of the disclosure, the “measurement” mentioned may be not limited to QoE and/or RAN visible QoE (RVQoE) measurement, and can be other measurements. Similarly, the “measurement report” may be not limited to the QoE and/or RVQoE measurement report, but may be other measurement reports.

The nodes involved in the disclosure may be:
A first node 10, including but not limited to at least one of the following nodes: a receiving base station (or called a new base station or an accessing base station), or a centralized unit of the receiving/new/accessing base station, or a control plane part of the centralized unit of the receiving/new/accessing base station;
A second node 20, including but not limited to at least one of the following nodes: the last serving base station (or called an old base station or anchor base station), or the centralized unit of the last serving/old/anchor base station, or the control plane part of the centralized unit of the last serving/old/anchor base station;
A third node 30, including but not limited to at least one of the following nodes: a terminal, or an access stratum of a terminal;
A fourth node 40, including but not limited to at least one of the following nodes: a historical base station, or a base station where a terminal stayed, or a base station from which a terminal was served;
A fifth node 50, including but not limited to an application layer of a terminal.

In order to support the measurement and reporting of user experience related to multicast/broadcast service, the NR is required to support the user experience reporting when the terminal is in the idle or inactive state (not limited to QoE reporting and/or RVQoE reporting, but also being other measurement reporting). User experience reporting when the terminal is in the idle or inactive state needs to be realized by the SDT. However, the existing SDT technology cannot ensure that the user experience report of the terminal is reported to the appropriate base station or node.

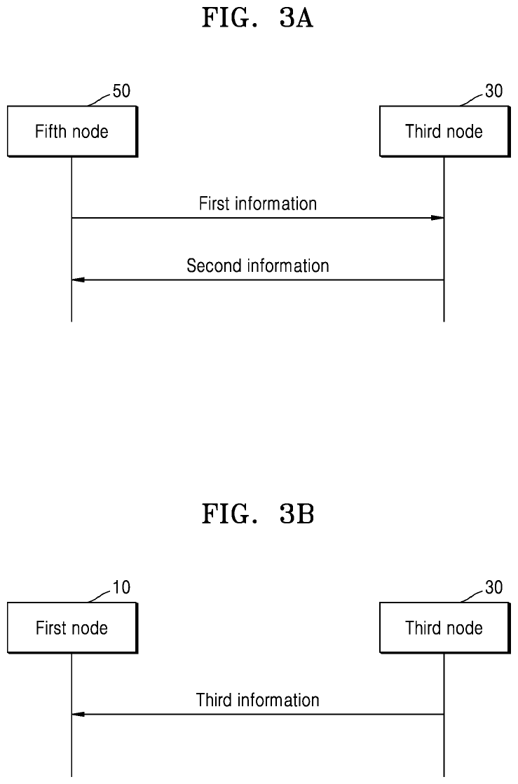

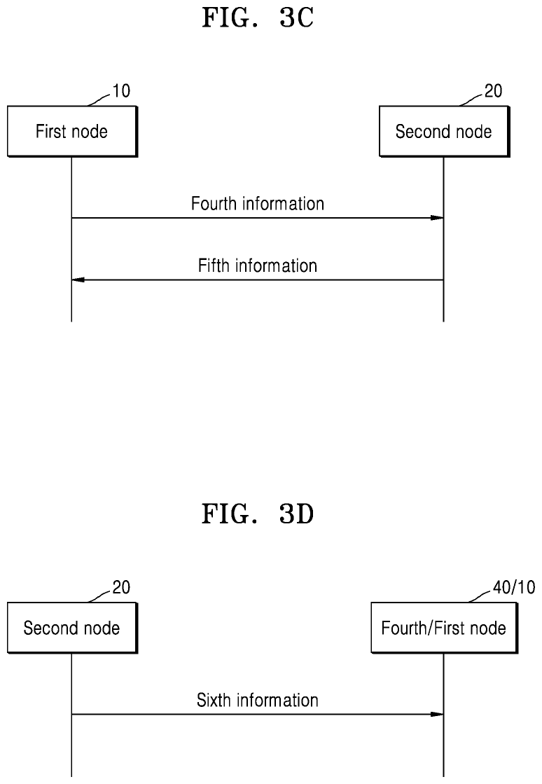

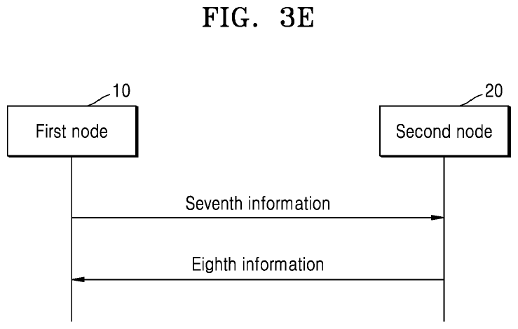

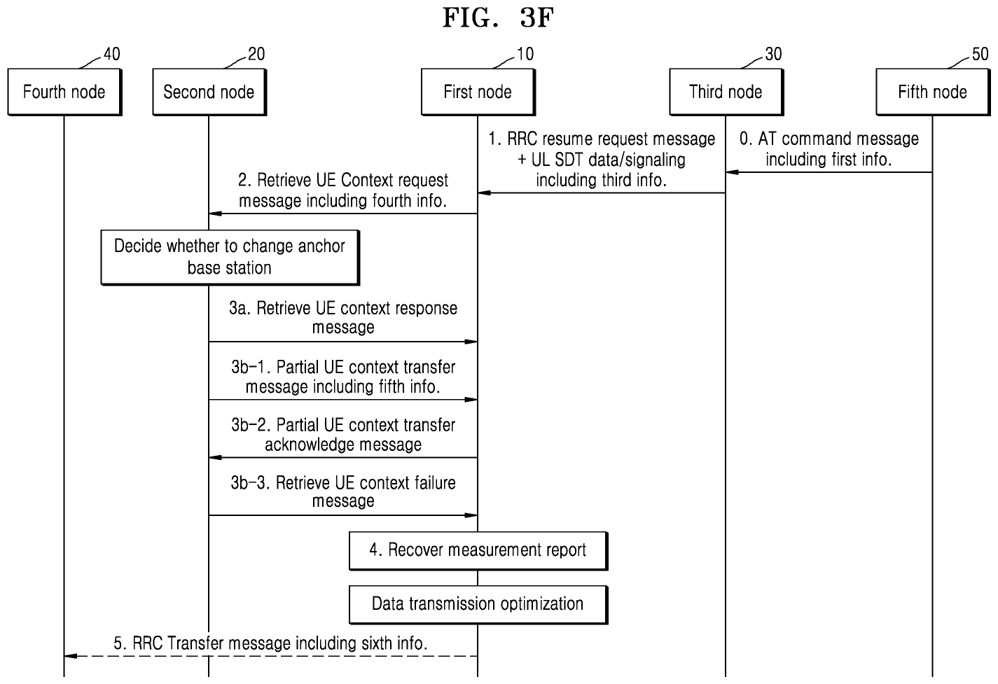

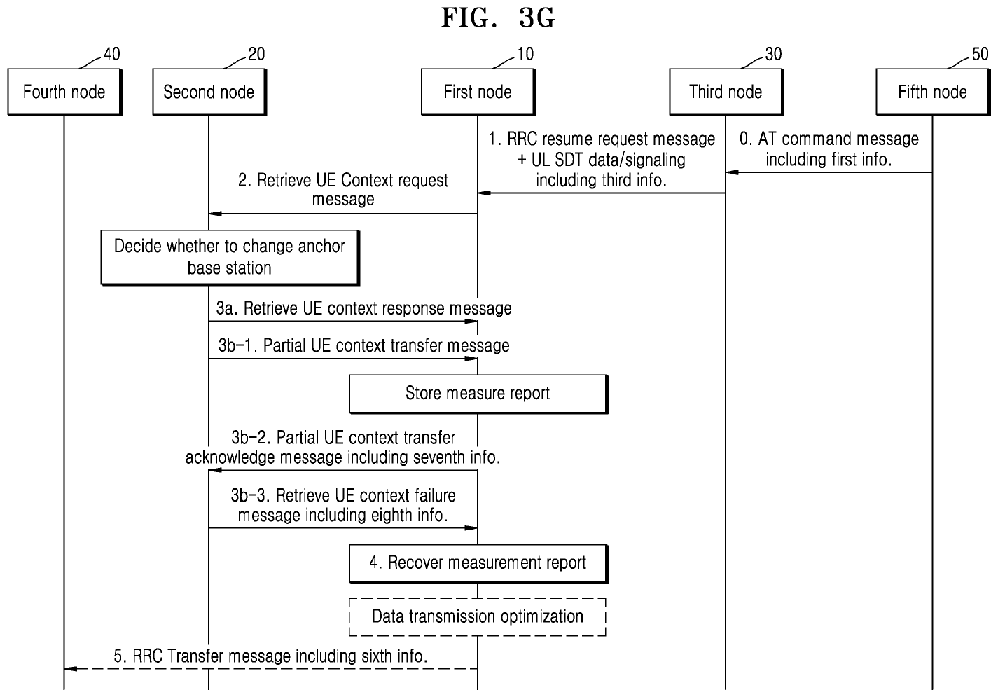

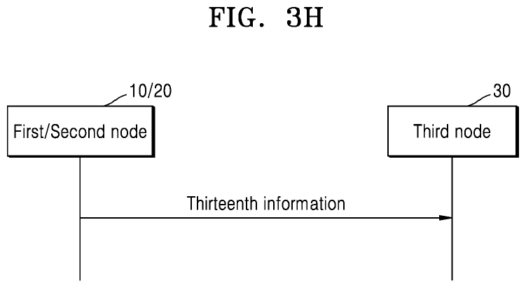

FIGS. 3A to 3I illustrate an enhancement of measurement report based on the SDT. By the embodiment of the disclosure, it can be ensured that the base station or node may receive the measurement (e.g., the quality of experience measurement) for the multicast/broadcast service, thus enabling the base station or node to enhance or optimize the subsequent data transmission. Moreover, by the embodiment of the disclosure, through optimization of the configuration interaction/exchange mode between nodes, it can be guaranteed that the base station or node can effectively report and receive the measurement, which avoids a lot of signaling interaction/exchange required for each measurement reporting and greatly saves the signaling interaction/exchange overhead. Moreover, by the embodiment of the disclosure, it can be ensured that the terminal aligns the measurement (e.g., the quality of experience measurement) with the minimization of drive tests by means of the signaling configuration, and effectively optimize the minimization of drive tests measurement, so as to avoid unnecessary collection of the minimization of drive tests measurement and save the storage space of the terminal measurement.

FIG. 3A illustrates a message transmission and reception for enhancement of measurement reporting based on a small data transmission (SDT) between third node and fifth node according to an embodiment of the disclosure.

Referring to FIG. 3A, the fifth node 50 may send first information to the third node 30, wherein the first information may include at least one of the following information:
Measurement report;
Information on measured cell(s) (e.g., cell identity information);
Identity information of the measurement report;
Information for requesting an identity of the cell for the terminal/UE currently;
Time information corresponding to the measurement (for example, time information related to the measured cell(s)); or
Time related information of the measurement.

In an embodiment of the disclosure, the time related information of the measurement may include at least one of the following information:
Time window/interval of measurement;
Starting time of the measurement;
Duration of the measurement; or
Ending time for the measurement.

The first information may be included in an existing AT command message or a new AT command message.

After receiving the first information, the third node 30 may identify or determine at least one of the following information according to the content in the first information:
Information on the measured cell(s) (e.g., cell identity information); (cell(s) may include one or more cells), or
Timing information corresponding to the measurement.

In an embodiment of the disclosure, the information on the measured cell(s) may include at least one of the following information:
Identity(ies) of the measured cell(s); or
Identity list of the measured cell(s).

In an embodiment of the disclosure, the identity(ies) of the measured cell(s) may contain at least one of the following information:
NR cell identity (NCI);
NR cell global identity (NCGI);
NR physical cell identity (NR PCI);
Cell identity (cell ID);
Cell global identity (cell global ID); or
Physical cell identity (physical cell ID).

In an embodiment of the disclosure, the identity list of the measured cell(s) may contain at least one of the following information:
NR cell identity (NCI) list;
NR cell global identity (NCGI) list;
NR physical cell identity (NR PCI) list;
Cell identity (cell ID) list;
Cell global identity (cell global ID) list; or
Physical cell identity (physical cell ID) list.

In an embodiment of the disclosure, the time information corresponding to the measurement may include at least the following information:

Time information related to the measured cell(s), for example, time information corresponding to each cell identity in the cell identity list, time information on the terminal staying at the cell, or the like.

In an embodiment of the disclosure, the time information corresponding to each cell identity in the cell identity list may include at least one for the following information:
Time window/interval of measurement;
Starting time of the measurement;
Duration of the measurement; or
Ending time for the measurement.

After determining the information on the measured cell(s), the third node 30 may perform one of the following operations:

Associating the information on the measured cell(s) with the measurement report or adding information on the measured cell(s) (e.g., cell identity information) to the measurement report; or

Sending the information on the measured cell(s) to the fifth node 50 via the second information.

Specifically, the second information may include at least one of the following information:
Identity information of the measurement report;
Information on the measured cell(s); or
Time information corresponding to the measurement.

After receiving the second information, the fifth node 50 may associate the information on the measured cell(s) with the measurement report, or add the information on the measured cell(s) to the measurement report.

FIG. 3B illustrates a message transmission and reception for enhancement of measurement reporting based on a SDT between first node and third node according to an embodiment of the disclosure.

Referring to FIG. 3B, the third node 30 may send the third information to the first node 10, wherein the third information at least includes one of the following information:
Indication information (for example, the indication information for indicating that the third information contains the measurement report);
Information related to the measurement report; or
Configuration related to the measurement, which may include the configuration information related to the quality of experience measurement, for example.

In an embodiment of the disclosure, the configuration related to the measurement may include at least one of the following information:
First periodicity; or
First trigger condition,
For example, the first periodicity may refer to a periodicity for the measurement reporting, and the first trigger condition may refer to a trigger condition that triggers the measurement reporting.

In an embodiment of the disclosure, the indication information may indicate that the reported measurement report or a part of the measurement report is measured by a terminal when the serving cell belongs to the first node.

The indication information may be included in an existing RRC resume request, may also be included in other existing RRC messages, or may also be included in a new RRC message.

In an embodiment of the disclosure, the information related to the measurement report may include at least one of the following information:
Measurement report;
Information on the measured cell(s); or
Time information corresponding to the measurement.

In an embodiment of the disclosure, the information on the measured cell(s) may include at least one of the following information:
Identity(ies) of the measured cell(s); or
Identity list of the measured cell(s).

In an embodiment of the disclosure, the identity(ies) of the measured cell(s) contains at least one of the following information:
NR cell identity (NCI);
NR cell global identity (NCGI);
NR physical cell identity (NR PCI);
Cell identity (cell ID);
Cell global identity (cell global ID); or
Physical cell identity (physical cell ID).

In an embodiment of the disclosure, the identity list of the measured cell(s) may contain at least one of the following information:
NR cell identity (NCI) list;
NR cell global identity (NCGI) list;
NR physical cell identity (NR PCI) list;
Cell identity (cell ID) list;
Cell global identity (cell global ID) list; or
Physical cell identity (physical cell ID) list.

In an embodiment of the disclosure, the time information corresponding to the measurement may include at least the following information:

Time information related to the measured cell(s), for example, time information corresponding to each cell identity in the cell identity list, time information on the terminal staying at the cell, or the like.

In an embodiment of the disclosure, the time information corresponding to each cell identity in the cell identity list may include at least one of the following information:
Time window/interval of measurement;
Starting time of the measurement;
Duration of the measurement; or
Ending time for the measurement.

After receiving the third information, the first node 10 may decide to store or keep all or part of the content in the received third information, or transmit all or part of the content in the received third information.

FIG. 3C illustrates a message transmission and reception for enhancement of measurement reporting based on a SDT between first node and second node according to an embodiment of the disclosure.

Referring to FIG. 3C, the first node 10 may send the fourth information to the second node 20, wherein the fourth information may include at least the following information:
Identity information of a UE context; or
Indication related to a measurement report.

In an embodiment of the disclosure, the indication related to the measurement report may indicate at least the following situations:

An indication for indicating that the measurement report is kept and/or stored in the first node, such as an indication for indicating that the QoE measurement report is kept and/or stored in the first node and/or an indication for indicating that the RVQoE measurement report is kept and/or stored in the first node, or the like.

The fourth information may be included in an existing XnAP RETRIEVE UE CONTEXT REQUEST message, or may also be included in an existing or new XnAP message.

After receiving the fourth information, the second node 20 may perform at least one of the following operations according to the content in the fourth information:
Modifying configuration related to the measurement;
Sending the fifth information to the first node,
wherein the fifth information includes at least one of the following information:
Configuration information of a radio bearer;
Configuration information of a radio bearer carrying the measurement report;
Configuration information of a signaling radio bearer SRB1 or SRB2 or SRB4;
Configuration related to the measurement;
Configuration related to a first duration; or
Request or indication related to the first duration.

In an embodiment of the disclosure, the first duration may refer to a duration in which the first node 10 may send the measurement report to the second node 20 without context interaction/exchange with the second node 20, and may also refer to a duration in which the first node 10 saves the context received from the second node 20.

In an embodiment of the disclosure, the configuration related to the measurement may include at least one of the following information:
First periodicity; or
First trigger condition,
wherein the first periodicity may refer to a periodicity for measurement reporting, and the first trigger condition may refer to a trigger condition that triggers the measurement reporting;
The fifth information may be included in an existing XnAP PARTIAL UE CONTEXT TRANSFER message or in an existing or new XnAP message.

After receiving the fifth information, the first node 10 may recover or partially recover the measurement report according to the content in the fifth information. Further, after receiving the fourth information, the above-mentioned second node 20 may perform at least one of the following operations according to the content in the fourth information:
Modifying the configuration related to the measurement; or
Sending the fifth information to the first node.

There are different methods for implementation based on the above two operations:
The first method: after receiving the fourth information, the second node 20 may directly send the fifth information, in which an unmodified configuration related to the measurement is included, to the first node 10 according to the content in the fourth information; after receiving the fifth information, the first node 10 may modify the configuration related to the measurement according to the content of the fifth information.

The second method: after receiving the fourth information, the second node 20 may modify the configuration related to the measurement according to the content in the fourth information, and includes the modified configuration related to the measurement in the fifth information and may send the fifth information to the first node 10; after receiving the fifth information, the first node 10 may directly use the configuration related to the measurement contained in the fifth information.

Referring to FIG. 3C, it can be ensured that the base station or node can receive the measurement for the multicast/broadcast service, thus enabling the base station or node to enhance or optimize the subsequent data transmission. And through optimization of the configuration interaction/exchange mode between nodes, it can be ensured that the base station or node can effectively report and receive the measurement, avoiding a lot of signaling interaction/exchange required for each measurement reporting, and greatly saving the signaling interaction/exchange overhead.

FIG. 3D illustrates a message transmission and reception for enhancement of measurement reporting based on a SDT according to an embodiment of the disclosure.

Although not illustrated in FIG. 3D, in an embodiment of the disclosure, the first node 10 may send the sixth information to the second node 20 or the fourth node 40.

Referring to FIG. 3D, in an embodiment of the disclosure, the second node 20 may send the sixth information to at least one node of the first node 10 or the fourth node 40. In an embodiment of the disclosure, the sixth information may include at least one of the following information:
Identity information of a radio bearer;
Information on measured cell(s);
Measurement report; or
Time information corresponding to the measurement.

Specifically, the identity information of the radio bearer may include at least one of the following information:
Identity of a signaling radio bearer;
Identity of a signaling radio bearer SRB1;
Identity of a signaling radio bearer SRB2; or
Identity of a signaling radio bearer SRB4.

The sixth information may be included in an existing XnAP RRC TRANSFER message, or may also be included in an existing or new XnAP message.

After receiving the sixth information, the first node 10, the second node 20 or the fourth node 40 may configure, enhance or optimize data transmission.

FIG. 3E illustrates a message transmission and reception for enhancement of measurement reporting based on the SDT between the first node and the second node according to an embodiment of the disclosure.

Referring to FIG. 3E, the first node 10 may send the seventh information to the second node 20, wherein the seventh information may include at least one of the following information:
Information related to the first node keeping/storing the measurement report, for example, an indication for indicating that the measurement report is kept and/or stored at the first node 10;
An indication for indicating that the information is received by the first node 10 through the signaling carried by a signaling radio bearer SRB4;
Configuration related to measurement;
Modified configuration related to the measurement;
Acknowledge/confirm to the configuration related to the measurement;
configuration related to a first duration;
Acknowledge/confirm to the first duration; or
Request or indication related to the first duration.

In an embodiment of the disclosure, the first duration may refer to a duration in which the first node 10 can send a measurement report to the second node 20 without context interaction/exchange with the second node 20, and may also refer to a duration in which the first node 10 saves the context received from the second node 10.

Specifically, the configuration related to the measurement may include at least one of the following information:
First periodicity; or
First trigger condition,
In an embodiment of the disclosure, the first periodicity may refer to a periodicity for measurement reporting, and the first trigger condition may refer to a trigger condition that triggers the measurement reporting.

In an embodiment of the disclosure, the information related to the first node keeping/storing the measurement report may be indication information that the kept/stored information is SRB4 signaling/data.

The seventh information may be included in an existing XnAP PARTIAL UE CONTEXT TRANSFER message, and may also be included in an existing or new XnAP message.

After receiving the seventh information, the second node 20 may send eighth information to the first node 10 according to the content of the seventh information. In an embodiment of the disclosure, the eighth information may include at least one of the following information:
Configuration information of a radio bearer;
Configuration information of a radio bearer carrying the measurement report;
Configuration information of a signaling radio bearer SRB1 or SRB2 or SRB4;
RRC release message, which contains the configuration related to the measurement;
Configuration related to the first duration; or
Acknowledge/confirm to the first duration.

In an embodiment of the disclosure, the first duration refers to a duration in which the first node 10 can send the measurement report to the second node 20 without context interaction/exchange with the second node 20, and may also refer to a duration in which the first node 10 may save the context received from the second node 20.

Specifically, the configuration related to the measurement may include at least one of the following information:
First periodicity; or
First trigger condition,

In an embodiment of the disclosure, the first periodicity may refer to a periodicity for measurement reporting, and the first trigger condition may refer to a trigger condition that triggers the measurement reporting.

The eighth information may be included in an existing XnAP RETRIEVE UE CONTEXT FAILURE message, or also may be included in an existing or new XnAP message.

After receiving the eighth information, the first node 10 may recover the measurement report according to the content in the eighth information.

The first node 10 may configure, enhance or optimize data transmission according to the recovered measurement report.

Referring to FIG. 3E, it can be ensured that the base station or node may receive the measurement for the multicast/broadcast service, thus enabling the base station or node to enhance and optimize the subsequent data transmission. And through optimization of the configuration interaction/exchange mode between nodes, it can be ensured that the base station or node can effectively report and receive the measurement, avoiding a lot of signaling interaction/exchange required for each measurement reporting, and greatly reducing signaling interaction/exchange overhead.

FIG. 3F is a flowchart for enhancement of RVQoE measurement reporting based on the SDT according to an embodiment of the disclosure.

Referring to FIG. 3F, it shows a procedure of reporting the RVQoE measurement using the SDT under the condition that RVQoE indication is defined (i.e., option 1).

At operation 0, the fifth node 50 may send an AT command message to the third node 30, the AT command message including the first information;

At operation 1, the third node 30 may send an RRC resume request message and at least one of uplink (UL) SDT data or signaling to the first node 10, in which the third information is included;

At operation 2, the first node 10 may send a Retrieve UE Context Request message to the second node 20, in which the fourth information is included; and the second node may decide whether to change the anchor base station according to the received message;

At operation 3a, the second node 20 may send a retrieve UE context response message to the first node 10;

At operation 3b-1, the second node 20 may send a partial UE context transfer message to the first node, in which the fifth information is included;

At operation 3b-2, the first node 10 may send a partial UE context transfer acknowledge message to the second node 20;

At operation 3b-3, the second node 20 may send a retrieve UE context failure message to the first node 10;

At operation 4, the first node to may recover the measurement report according to the received retrieve UE context response message or the partial UE context transfer message which contains the fifth information; and optimize data transmission according to the content of the measurement report;

At operation 5, the first node 10 may send an RRC transfer message to the fourth node 40, in which the sixth information is included.

FIG. 3G is a flowchart for enhancement of RVQoE measurement reporting based on the SDT according to an embodiment of the disclosure.

Referring to FIG. 3G, it shows the procedure of the RVQoE measurement reporting using the SDT under the condition that the RVQoE indication is not defined (that is, option 2).

At operation 0, the fifth node 50 may send an AT command message to the third node 30, in which the first information is included;

At operation 1, the third node 30 may send an RRC resume request message and UL SDT data/signaling to the first node, in which the third information is included;

At operation 2, the first node may send a retrieve UE context request message to the second node 20, and the second node may decide whether to change the anchor base station according to the received message;

At operation 3a, the second node 20 may send a retrieve UE context response message to the first node 10;

At operation 3b-1, the second node 20 may send a partial UE context transfer message to the first node 10, and the first node 10 may store (and/or save) the measurement report according to the received content;

At operation 3b-2, the first node 10 may send a partial UE context transfer acknowledge message to the second node 20, in which the seventh information is included;

At operation 3b-3, the second node may send a retrieve UE context failure message to the first node 10, in which the eighth information is included;

At operation 4, the first node 10 may recover the measurement report according to the received retrieve UE context response message or the retrieve UE context failure message containing the eighth information; and optimize data transmission according to the content of the measurement report;

At operation 5, the first node 10 may send an RRC transfer message to the fourth node 40, in which the sixth information is included.

FIG. 3H illustrates a message transmission and reception for enhancement of RVQoE measurement reporting based on the SDT between nodes according to an embodiment of the disclosure.

Referring to FIG. 3H, the first node 10 or the second node 20 may send thirteenth information to the third node 30, wherein the thirteenth information may include at least one of the following information:
Configuration related to measurement;
Modified configuration related to the measurement;
Configuration of minimization of drive tests measurement; or
Alignment indication information for indicating whether the minimization of drive tests measurement is only used for aligning with the quality of experience measurement.

The thirteenth information may be included in an existing RRC release message, and also may be included in an existing or new RRC message.

After receiving the thirteenth information, the third node 30 may perform the measurement and/or the minimization of drive tests measurement according to the content in the thirteenth information.

By the way described in FIG. 3H, it can be ensured that the base station or node can receive the measurement for the multicast/broadcast service, thus enabling the base station or node to enhance and optimize the subsequent data transmission. In addition, by means of the signaling configuration, it is ensured that the terminal aligns the measurement with the minimization of drive tests, and effectively optimizes the minimization of drive tests measurement, so as to avoid unnecessary collection of the minimization of drive tests measurement and save the storage space of the terminal for the measurement.

FIG. 3I is a flowchart for enhancement of RVQoE measurement reporting based on a SDT between a first node, a second node and third node according to an embodiment of the disclosure.

Referring to FIG. 3I, it shows the procedure of configuring and reporting the user experience measurement using the SDT.

At operation 1, the second node 20 may send an RRC release message to the third node 30, in which the thirteenth information is included;

At operation 2, the third node 30 may send an RRC resume request message and at least one of UL SDT data, or signaling to the first node 10, in which the third information is included;

At operation 3, the first node 10 may send a retrieve UE context request message to the second node 20, and the second node 20 may decide whether to change the anchor base station according to the received message;

At operation 3a, the second node 20 may send a retrieve UE context response message to the first node 10, and the first node 10 may modify or update the measurement configuration if necessary according to the received message;

At operation 3b-1, the second node 20 may send a partial UE context transfer message to the first node 10, in which the fifth information is included;

At operation 3b-2, the first node 10 may send a partial UE context transfer acknowledge message to the second node 20, in which the seventh information is included;

At operation 3b-3, the second node 20 may send a retrieve UE context failure message to the first node 10, in which the eighth information is included;

At operation 3b-4, the first node 10 may store and/or save the UE context during the first duration according to the eighth information (including the first duration) in the received retrieve UE context failure message;

At operation 4, the first node 10 may send an RRC release message to the third node 30, in which the thirteenth information is included.

Referring to FIG. 3I, it can be ensured that the base station or node can receive the measurement for multicast/broadcast service, thus enabling the base station or node to enhance and optimize the subsequent data transmission. And through optimization of the configuration interaction/exchange mode between nodes, it can be ensured that the base station or node can effectively report and receive the measurement, avoiding a lot of signaling interaction/exchange required for each measurement reporting, and greatly saving signaling interaction/exchange overhead. In addition, by means of the signaling configuration, it can be ensured the terminal aligns the measurement with the minimization of drive tests, thus effectively optimizing the minimization of drive tests measurement, avoiding unnecessary collection of the minimization of drive tests measurement, and reducing the storage space of the terminal for the measurement.

In order to support measurement and reporting related to user experience for multicast/broadcast service, the NR is required to support user experience reporting for multicast/broadcast services and/or the slice-based user experience reporting. When the terminal (i.e., UE in the disclosure) is in any RRC state (including a connected state, an idle state or an inactive state), it needs to support slice-based user experience reporting. However, the existing user experience reporting technology cannot support the user experience reporting for multicast/broadcasting service and/or the slice-based user experience reporting.

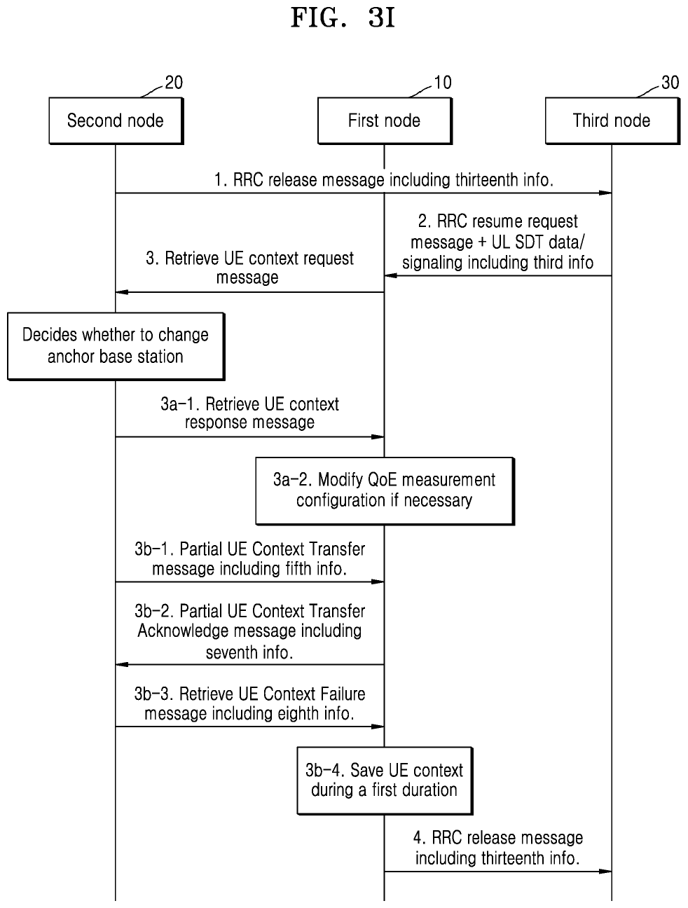

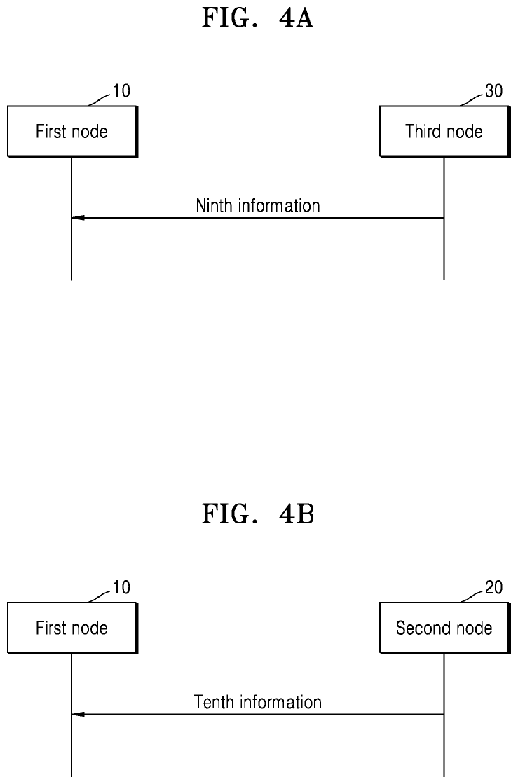

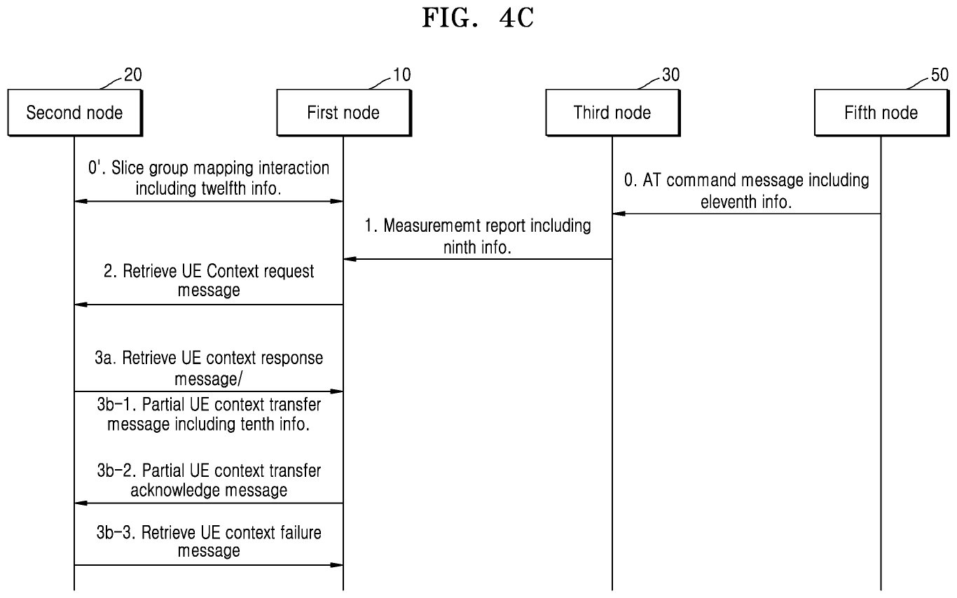

FIGS. 4A and 4B illustrate an enhancement of the slice-based user experience measurement reporting. Through the embodiment of the disclosure, it can be ensured that the base station or node can receive the measurement related to user experience for the multicast/broadcast service and/or based on the slice, thereby enabling the base station or node to obtain service and/or slice information corresponding to the measurement reporting, and enabling the base station or node to carry out enhancement and optimization of the subsequent data transmission for the appropriate multicast/broadcast service and/or slice.

FIG. 4A illustrates a message transmission and reception for enhancement of measurement reporting based on service and/or slice between the first node and the third node according to an embodiment of the disclosure.

Although not illustrated in FIG. 4A, the third node 30 may receive eleventh information from the fifth node 50, wherein the eleventh information at least includes the following information:
Measurement report,
wherein the eleventh information may be included in an existing or new AT command message.

Referring to FIG. 4A, after receiving the eleventh information, the third node 30 may send ninth information to the first node 10. In an embodiment of the disclosure, the ninth information may include at least one of the following information:
Multicast/broadcast service session identity (MBS session ID);
Quality of service flow identity (QFI, QoS Flow ID);
Multicast radio bearer identity (MRB ID);
First identity (for example, a first identity for identifying the multicast/broadcast service MBS);
Slice identity (slice ID or S-NSSAI);
Slice group identity (NSAG ID, network slice AS group ID);
Cell identity;
Cell identity List;
Packet data unit set sequence number (PDU set sequence number);
List of packet data unit set sequence number;
Range of packet data unit set sequence number;
Packet data unit sequence number within packet data unit set;
List of packet data unit sequence number within packet data unit set;
Range of packet data unit sequence number within packet data unit set; or
Packet data unit set importance (PDU set importance).

In an embodiment of the disclosure, the first identity may be a part of a multicast/broadcast service session identity, may also be a short identity corresponding/mapped to the multicast/broadcast service session identity, or may also be an identity corresponding/mapped to the multicast/broadcast service session identity.

In an embodiment of the disclosure, the slice group identity may be a slice group identity of a tracking area where the reporting cell belongs to, may also be a slice group identity of a tracking area where a cell sending a RRC connection release belongs to, or may also be a slice group identity of a tracking area which the cell identity belongs to.

In an embodiment of the disclosure, the packet data unit set importance may be used to identify the importance of a packet data unit set in a QoS flow.

After receiving the ninth information, the first node may determine at least one of service or slice information of the measurement reporting according to the content of the ninth information.

FIG. 4B illustrates a message transmission and reception for enhancement of measurement reporting based on service and/or slice between the first node and the second node according to an embodiment of the disclosure.

Although not illustrated in FIG. 4B, the first node 10 may send twelfth information to the second node 20, or the second 20 node may send the twelfth information to the first node 10. In an embodiment of the disclosure, the twelfth information may include at least one of the following information:

Association information between network slicing AS group (NSAG) and slice(s),

In an embodiment of the disclosure, the twelfth information may be included in an existing XnAP XN SETUP REQUEST/RESPONSE message, may also be included in an existing XnAP NG-RAN NODE CONFIGURATION UPDATE message, or may also be included in other existing or new XNAP messages.

Referring to FIG. 4B, after receiving the twelfth information, the second node 20 may send tenth information to the first node 10. In an embodiment of the disclosure, the tenth information may include at least one of the following information:
Association/mapping information between the multicast/broadcast service session identity and the first identity (for example, the first identity used to identify the multicast/broadcast service MBS);
Configuration information of a radio bearer;
Configuration information of a radio bearer for carrying the measurement report; or
Configuration information of a signaling radio bearer SRB1 or SRB2 or SRB4,

In an embodiment of the disclosure, the tenth information may be included in an existing XnAP RETRIEVE UE CONTEXT REQUEST message, may also be included in an existing XnAP PARTIAL UE CONTEXT TRANSFER message, or may also be included in other existing or new XnAP message.

FIG. 4C illustrates an enhancement of RVQoE measurement reporting based on service and/or slice according to an embodiment of the disclosure.

Referring to FIG. 4C, it shows the procedure of reporting at least one of service or slice-based RVQoE measurement.

At operation 0′, the first node 10 and the second node 20 may interact and/or exchange mapping information between the slice group and the slice(s), in which the twelfth information is included;

At operation 0, the fifth node 50 may send an AT command message to the third node 30, in which the eleventh information is included;

At operation 1, the third node 30 may send the measurement report to the first node 10, in which the ninth information is included;

At operation 2, the first node 10 may send a retrieve UE context request message to the second node 20;

At operation 3a, the second node 20 may send a retrieve UE context response message to the first node 10, in which the tenth information is included;

At operation 3b-1, the second node 20 may send a partial UE context transfer message to the first node 10, in which the tenth information is included;

At operation 3b-2, the first node 10 may send a partial UE context transfer acknowledge message to the second node 20;

At operation 3b-3, the second node 20 may send a retrieve UE context failure message to the first node 10.

Through the above embodiment of the disclosure, it can be ensured that the base station can receive radio access network visible user experience related measurement for multicast/broadcasting service, thus enabling enhancement and optimization of the subsequent data transmission.

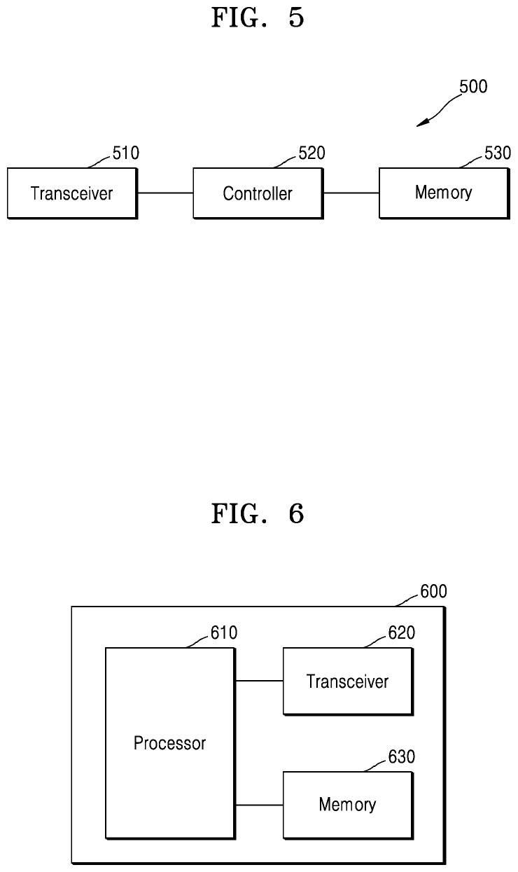

FIG. 5 is a block diagram of a node device in a network according to an embodiment of the disclosure.

Referring to FIG. 5, a node device 500 in the network may be used to implement a DU, a CU-UP, a CU-CP, a gNB, an eNB source base station, a target base station, a source DU, a source CU-UP, a source CU-CP, a target DU, a target CU-UP, a target CU-CP, a master base station, a secondary base station, an OAM, a unified data management (UDM) entity, an AMF entity, an SMF entity or a UPF entity, and, or the like, in the disclosure.

In an embodiment of the disclosure, the node device 500 may correspond to at least one of the first node 10, the second node 20, the third node 30, the fourth node, or the fifth node.

Referring to FIG. 5, the node device 500 according to the disclosure includes a transceiver 510, a controller 520 and a memory 530. The transceiver 510, the controller 520 and the memory 530 are configured to perform the operations of the methods and/or embodiments of the disclosure. Although the transceiver 510, the controller 520 and the memory 530 are illustrated as separated entities, they can be implemented as a single entity, such as a single chip. The transceiver 510, the controller 520 and the memory 530 may be electrically connected or coupled to each other. The transceiver 510 can send signals to other network devices and receive signals from other network entities, such as a UE, a base station or a core network node. The controller 520 may include one or more processing units, and may control network devices to perform operations and/or functions according to one of the above embodiments. The memory 530 may store instructions for implementing the operations and/or functions of one of the above embodiments.

FIG. 6 schematically illustrates a base station according to an embodiment of the disclosure.

Referring to the FIG. 6, a base station 600 may include a processor 610, a transceiver 620 and a memory 630. However, all of the illustrated components are not essential. The base station 600 may be implemented by more or less components than those illustrated in FIG. 6. In addition, a processor 610 and the transceiver 620 and the memory 630 may be implemented as a single chip according to another embodiment.

In an embodiment of the disclosure, the base station 600 may correspond to the base station described above. For example, the base station 600 may correspond to at least one of eNodeB, NodeB, the gNB, or the ng-gNB and may be not limited to the examples described above.

In addition, the base station 600 may correspond to at least one of the first node 10, the second node 20, or the fourth node.

The aforementioned components will now be described below.

The processor 610 may include one or more processors or other processing devices that control the proposed function, process, and/or method. Operation of the base station 600 may be implemented by the processor 610.

The transceiver 620 may include a RF transmitter for up-converting and amplifying a transmitted signal, and a RF receiver for down-converting a frequency of a received signal. However, according to another embodiment of the disclosure, the transceiver 620 may be implemented by more or less components than those illustrated in components.

The transceiver 620 may be connected to the processor 610 and transmit and/or receive a signal. The signal may include control information and data. In addition, the transceiver 620 may receive the signal through a wireless channel and output the signal to the processor 610. The transceiver 620 may transmit a signal output from the processor 610 through the wireless channel.

The memory 630 may store the control information or the data included in a signal obtained by the base station 600. The memory 630 may be connected to the processor 610 and store at least one instruction or a protocol or a parameter for the proposed function, process, and/or method. The memory 630 may include a read-only memory (ROM) and/or a random access memory (RAM) and/or a hard disk and/or a compact disc-ROMs (CD-ROM) and/or a digital versatile disc (DVD) and/or other storage devices.

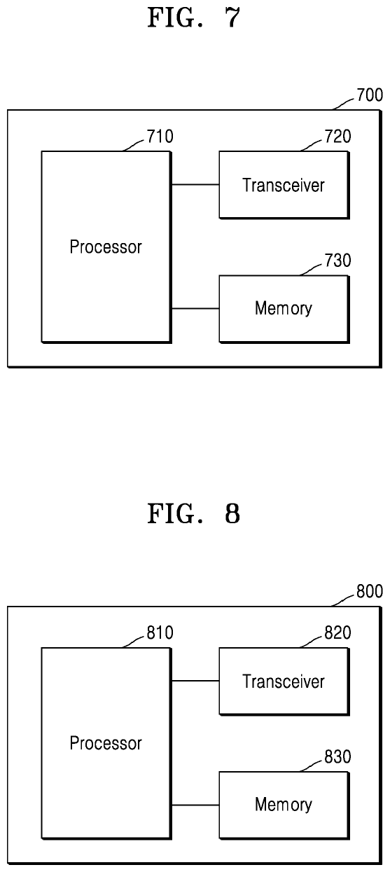

FIG. 7 illustrates a user equipment (UE) according to an embodiment of the disclosure.

Referring to the FIG. 7, a UE 700 may include a processor 710, a transceiver 720 and a memory 730. However, all of the illustrated components are not essential. The UE 700 may be implemented by more or less components than those illustrated in FIG. 7. In addition, the processor 710 and the transceiver 720 and the memory 730 may be implemented as a single chip according to another embodiment.

In an embodiment of the disclosure, the UE 700 may correspond to a UE described above. For example, the UE 700 may correspond to the UE 101, the UE 151, terminal and may be not limited to the examples described above.

In addition, the UE 700 may correspond to at least one of the third node 30, or the fifth node 50.

The aforementioned components will now be described below.

The processor 710 may include one or more processors or other processing devices that control the proposed function, process, and/or method. Operation of the UE 700 may be implemented by the processor 710.

The transceiver 720 may include a RF transmitter for up-converting and amplifying a transmitted signal, and a RF receiver for down-converting a frequency of a received signal. However, according to another embodiment of the disclosure, the transceiver 720 may be implemented by more or less components than those illustrated in components.

The transceiver 720 may be connected to the processor 710 and transmit and/or receive a signal. The signal may include control information and data. In addition, the transceiver 720 may receive the signal through a wireless channel and output the signal to the processor 710. The transceiver 720 may transmit a signal output from the processor 710 through the wireless channel.

The memory 730 may store the control information or the data included in a signal obtained by the UE 700. The memory 730 may be connected to the processor 710 and store at least one instruction or a protocol or a parameter for the proposed function, process, and/or method. The memory 730 may include a ROM and/or a RAM and/or a hard disk and/or a CD-ROM and/or a DVD and/or other storage devices.

FIG. 8 illustrates an entity according to an embodiment of the disclosure.

Referring to the FIG. 8, an entity 800 may include a processor 810, a transceiver 820 and a memory 830. However, all of the illustrated components are not essential. The entity 800 may be implemented by more or less components than those illustrated in FIG. 8. In addition, the processor 810 and the transceiver 820 and the memory 830 may be implemented as a single chip according to another embodiment.

In an embodiment of the disclosure, the entity 800 may correspond to a network entity described above. For example, the entity 800 may correspond to the SGW 104, the PGW 105, the PCRF 106, the MME 103, the SGSN 108, the HSS 109, the AMF entity 153, the UPF entity 154, the SMF entity 155, the DN 156 and may be not limited to the examples described above.

In addition, the entity 800 may correspond to at least one of the first node 10, the first node 20, the third node 30, the fourth node 40, or the fifth node 50.

The aforementioned components will now be described below.

The processor 810 may include one or more processors or other processing devices that control the proposed function, process, and/or method. Operation of the entity 800 may be implemented by the processor 810.

The transceiver 820 may include a RF transmitter for up-converting and amplifying a transmitted signal, and a RF receiver for down-converting a frequency of a received signal. However, according to another embodiment of the disclosure, the transceiver 820 may be implemented by more or less components than those illustrated in components.

The transceiver 820 may be connected to the processor 810 and transmit and/or receive a signal. The signal may include control information and data. In addition, the transceiver 820 may receive the signal through a wireless channel and output the signal to the processor 810. The transceiver 820 may transmit a signal output from the processor 810 through the wireless channel.

The memory 830 may store the control information or the data included in a signal obtained by the entity 800. The memory 830 may be connected to the processor 810 and store at least one instruction or a protocol or a parameter for the proposed function, process, and/or method. The memory 830 may include a ROM and/or a RAM and/or a hard disk and/or a CD-ROM and/or a DVD and/or other storage devices.

It may be understood by those skilled in the art that computer program instructions may be used to realize each block in structure diagrams and/or block diagrams and/or flowcharts as well as a combination of blocks in the structure diagrams and/or block diagrams and/or flowcharts. It may be understood by those skilled in the art that these computer program instructions may be provided to general purpose computers, special purpose computers or other processors of programmable data processing means to be implemented, so that solutions designated in a block or blocks of the structure diagrams and/or block diagrams and/or flow diagrams are performed by computers or other processors of programmable data processing means.

It may be understood by those skilled in the art that the operations, methods, steps in the flows, measures and solutions already discussed in the application may be alternated, changed, combined or deleted. Further, the operations, methods, other steps in the flows, measures and solutions already discussed in the application may also be alternated, changed, rearranged, decomposed, combined or deleted. Further, prior arts having the operations, methods, the steps in the flows, measures and solutions already discussed in the application may also be alternated, changed, rearranged, decomposed, combined or deleted.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first node in a wireless communication network, the method comprising:
receiving, from a third node, third information; and
receiving, from a second node, fifth information,
wherein the fifth information includes at least one of configuration information of a radio bearer, configuration information of a radio bearer carrying a measurement report, configuration information of a signaling radio bearer (SRB), configuration information related to a measurement, configuration information related to a duration, or information for requesting or indicating the duration, and
wherein the third information includes information on at least one measured cell.

2. The method of claim 1, further comprising:
storing at least one piece of the received third information; and
transmitting, to the second node or a fourth node, sixth information,
wherein the sixth information includes at least one of identity information of a radio bearer, information on the at least one measured cell, the measurement report, or time information corresponding to the measurement.

3. The method of claim 1, further comprising:
transmitting, to the second node, fourth information,
wherein the fifth information is received based on the fourth information, and
wherein the fourth information includes identity information of user equipment (UE) context.

4. The method of claim 1, wherein the configuration information related to the duration includes information about a duration in which the first node does not need to perform context exchange with the second node, or a duration in which the first node keeps the context received from the second node.

5. The method of claim 1, further comprising:
transmitting, to the second node, seventh information; and
receiving, from the second node, eighth information, based on the seventh information,
wherein the seventh information includes at least one of indication for indicating that the measurement report is stored at the first node, indication for indicating that information is received by the first node through signaling carried by the SRB, configuration information related to the measurement, modified configuration information related to the measurement, an acknowledge to the configuration information related to the measurement, configuration information related to the duration, an acknowledge to the duration; or a request or an indication related to the duration, and
wherein the eighth information includes at least one of configuration information of a radio bearer, configuration information of a radio bearer carrying the measurement report, configuration information of the SRB, radio resource control (RRC) message containing the configuration information related to the measurement, configuration information related to the duration, or an acknowledge to the duration.

6. The method of claim 1, wherein the third information further includes at least one of indication information for indicating that the third information contains the measurement report, the measurement report, time information corresponding to a measurement, or configuration information related to the measurement.

7. The method of claim 6,
wherein the time information corresponding to the measurement includes time information related to the at least one measured cell, and
wherein the configuration information related to the measurement includes at least one of a reporting periodicity related to the measurement, or a triggering condition related to measurement reporting.

8. The method of claim 1, wherein the information on the at least one measured cell includes at least one of an identity corresponding to the at least one measured cell, or an identity list of the at least one measured cell.

9. The method of claim 1, further comprising:
recovering the measurement report, based on the fifth information.

10. A method performed by a second node in a wireless communication network, the method comprising:
receiving, from a first node, fourth information; and
transmitting, to the first node, fifth information, based on the fourth information,
wherein the fourth information includes identity information of user equipment (UE) context, and
wherein the fifth information includes at least one of configuration information of a radio bearer, configuration information of a radio bearer carrying a measurement report, configuration information of a signaling radio bearer (SRB), configuration information related to a measurement, configuration information related to a duration, or information for requesting or indicating the duration.

11. The method of claim 10, further comprising:
receiving, from the first node, sixth information,
wherein the sixth information includes at least one of identity information of a radio bearer, information on at least one measured cell, the measurement report, or time information corresponding to a measurement.

12. The method of claim 10, wherein the configuration information related to the duration includes information about a duration in which the first node does not need to perform context exchange with the second node, or a duration in which the first node keeps the context received from the second node.

13. The method of claim 10, further comprising:
receiving, from the first node, seventh information; and
transmitting, to the first node, eighth information, based on the seventh information,
wherein the seventh information includes at least one of indication for indicating that the measurement report is stored at the first node, indication for indicating that information is received by the first node through signaling carried by the SRB, configuration information related to the measurement, modified configuration information related to the measurement, an acknowledge to the configuration information related to the measurement, configuration information related to the duration, an acknowledge to the duration; or a request or an indication related to the duration, and
wherein the eighth information includes at least one of configuration information of a radio bearer, configuration information of a radio bearer carrying the measurement report, configuration information of the SRB, radio resource control (RRC) message containing the configuration information related to the measurement, configuration information related to the duration, or an acknowledge to the duration.

14. A first node performed in a wireless communication network, the first node comprising:
a transceiver; and
at least one processor coupled to the transceiver and configured to:
control the transceiver to receive, from a third node, third information, and
control the transceiver to receive, from a second node, fifth information,
wherein the fifth information includes at least one of configuration information of a radio bearer, configuration information of a radio bearer carrying a measurement report, configuration information of a signaling radio bearer (SRB), configuration information related to a measurement, configuration information related to a duration, or information for requesting or indicating the duration, and
wherein the third information includes information on at least one measured cell.

15. The first node of claim 14,
wherein the at least one processor is further configured to:
store at least one piece of the received third information, and
control the transceiver to transmit, to the second node or a fourth node,
sixth information, and
wherein the sixth information includes at least one of identity information of a radio bearer, information on the at least one measured cell, the measurement report, or time information corresponding to a measurement.

16. The first node of claim 14,
wherein the at least one processor is further configured to:
control the transceiver to transmit, to the second node, fourth information,
wherein the fifth information is received based on the fourth information, and
wherein the fourth information includes identity information of user equipment (UE) context.

17. The first node of claim 14, wherein the configuration information related to the duration includes information about a duration in which the first node does not need to perform context exchange with the second node, or a duration in which the first node keeps the context received from the second node.

18. The first node of claim 14,
wherein the at least one processor is further configured to:
control the transceiver to transmit, to the second node, seventh information, and
control the transceiver to receive, from the second node, eighth information, based on the seventh information,
wherein the seventh information includes at least one of indication for indicating that the measurement report is stored at the first node, indication for indicating that information is received by the first node through signaling carried by the SRB, configuration information related to the measurement, modified configuration information related to the measurement, an acknowledge to the configuration information related to the measurement, configuration information related to the duration, an acknowledge to the duration; or a request or an indication related to the duration, and
wherein the eighth information includes at least one of configuration information of a radio bearer, configuration information of a radio bearer carrying the measurement report, configuration information of the SRB, a radio resource control (RRC) message containing the configuration information related to the measurement, configuration information related to the duration, or an acknowledge to the duration.

19. The first node of claim 14, wherein the third information further includes at least one of indication information for indicating that the third information contains the measurement report, the measurement report, time information corresponding to a measurement, or configuration information related to the measurement.

20. The first node of claim 19,
wherein the time information corresponding to the measurement includes time information related to the at least one measured cell, and
wherein the configuration information related to the measurement includes at least one of a reporting periodicity related to the measurement, or a triggering condition related to measurement reporting.
